(19) United States
(12) Patent Application Publication
(10) Pub. No.: US 2024/0317340 A1
(43) Pub. Date: Sep. 26, 2024

(54) CONTROL SYSTEM, SERVER, AND VEHICLE

(71) Applicant: TOYOTA JIDOSHA KABUSHIKI KAISHA, Toyota-shi (JP)

(72) Inventors: Shogo YASUYAMA, Okazaki-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/442,194

(22) Filed: Feb. 15, 2024

(30) Foreign Application Priority Data
Mar. 23, 2023 (JP) 2023-046462
Oct. 6, 2023 (JP) 2023-174021

(51) Int. Cl. B62D 65/18; G05D 1/644; G05D 101/00; G05D 107/70; G07C 5/00

(52) U.S. Cl. CPC B62D 65/18; G05D 1/644; G07C 5/008; G05D 2101/22; G05D 2107/70

(57) ABSTRACT

A control system for controlling transport of a vehicle in any of steps from production to shipment of the vehicle includes a state identification unit that identifies a vehicle state that is a state of the vehicle, and a control notification unit that determines a control content of the vehicle by using the identified vehicle state and notifies the vehicle of the control content. The control notification unit determines to control at least either one of a transport route of the vehicle and a timing of starting the transport as the control content such that a magnitude of a difference between the vehicle state and a preset target state is suppressed.

### CROSS-REFERENCE TO RELATED APPLICATIONS

This patent application claims priority based upon Japanese patent application No. 2023-046462, filed on Mar. 23, 2023 and Japanese patent application No. 2023-174021, filed on Oct. 6, 2023, the entire disclosure of which is incorporated herein by reference.

### BACKGROUND

### Field

The present disclosure relates to a control system, a server, and a vehicle.

### Related Art

To efficiently operate a manufacturing system for producing vehicles, known is a vehicle running method for causing a vehicle to run from a terminal end of an assembly line of the manufacturing system to a parking lot in the manufacturing system by means of remote control or the like (see, for example, Japanese Unexamined Patent Application Publication (Translation of PCT Application) No. 2017-538619).

In a manufacturing factory for manufacturing vehicles, for example, differences in vehicle transport routes or differences in inspection time and the number of inspections in the inspection step may cause variations in the vehicle state such as the remaining amounts of fuel and battery at the time of shipment or the number of operations of the driving device. Such variations in the vehicle state may lead to variations in the vehicle quality, which is thus not preferable.

In a manufacturing factory for manufacturing vehicles, for example, differences in vehicle transport routes or differences in inspection time and the number of inspections in the inspection step may cause variations in the vehicle state such as the remaining amounts of fuel and battery at the time of shipment or the number of operations of the driving device. Such variations in the vehicle state may lead to variations in the vehicle quality, which is thus not preferable.

### SUMMARY

According to one aspect of the present disclosure, a control system is provided. The control system controls transport of a vehicle in any of steps from production to shipment of the vehicle and includes a state identification unit that identifies a vehicle state that is a state of the vehicle, and a control notification unit that determines a control content of the vehicle by using the identified vehicle state and notifies the vehicle of the control content, wherein the control notification unit determines to control at least either one of a transport route of the vehicle and a timing of starting the transport as the control content such that a magnitude of a difference between the vehicle state and a preset target state is suppressed.

### BRIEF DESCRIPTION OF THE DRAWINGS

FIG. 1 is an explanatory view illustrating a schematic configuration of a control system of a first embodiment;

FIG. 2 is an explanatory view illustrating automatic driving control of a vehicle by means of remote control;

FIG. 3A is a flowchart illustrating a procedure of transport control of the first embodiment;

FIG. 3B is a flowchart illustrating a procedure of running control of the first embodiment;

FIG. 4 is an explanatory view illustrating an example of how the vehicle is transported by the transport control of the first embodiment;

FIG. 5 is a flowchart illustrating a procedure of transport control of a second embodiment;

FIG. 6 is an explanatory view illustrating an example of how the vehicle is transported by the transport control of the second embodiment; and

FIG. 7 is a flowchart illustrating a processing procedure of running control of the vehicle in a third embodiment.

### DETAILED DESCRIPTION

### A. First Embodiment

### A-1. System Configuration

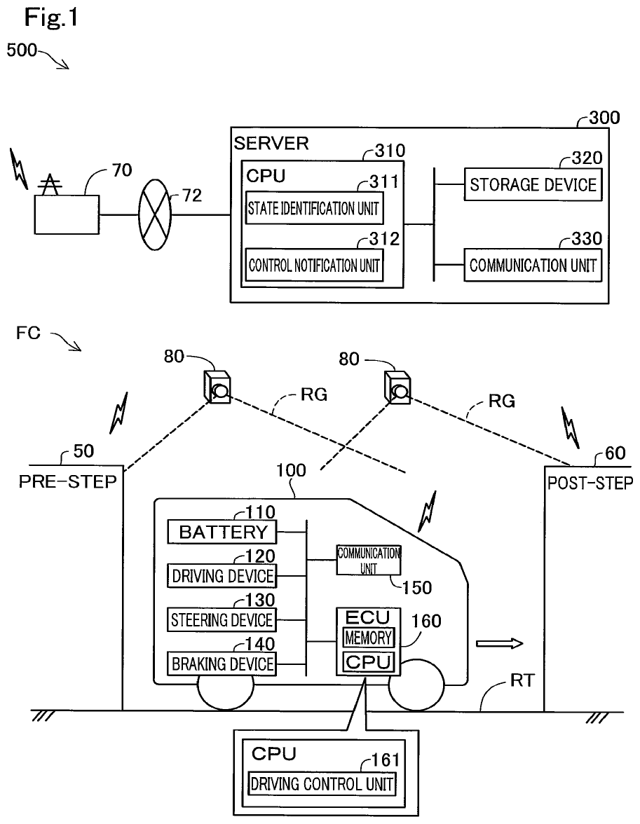

FIG. 1 is an explanatory view illustrating a schematic configuration of a control system 500 of a first embodiment. The control system 500 controls transport of a vehicle 100, which is an example of a “moving object,” in any of steps from production to shipment of the vehicle 100. The vehicle 100 is controlled by the control system 500 and transported by running by itself in a manufacturing process in a factory FC. In the present embodiment, the control system 500 controls automatic driving of the vehicle 100 by remote control and causes the vehicle 100 to automatically run in the manufacturing process in the factory FC where the vehicle 100 is manufactured. In the present embodiment, the vehicle 100 is configured to be able to run by unmanned driving. The vehicle 100 is configured as an electric automobile in the present embodiment. Note that the vehicle 100 is not limited to an electric automobile and may be, for example, a gasoline automobile, a hybrid automobile, or a fuel cell automobile. A vehicle in a complete state as a product and a vehicle in a state of a semi-finished or in-process product being manufactured are herein collectively referred to as the “vehicle.”

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a construction vehicle, or a combat vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board the vehicle 100 running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

As illustrated in FIG. 1, the factory FC includes a pre-step 50, a post-step 60, a track RT of the vehicle 100, and a vehicle detector. The track RT is a section connecting the pre-step 50 and the post-step 60 for transporting the vehicle 100 in the factory FC. The factory FC is not limited to cases where it is a single building, it is located at a single site or address, and the like. For example, each of the steps in the manufacturing process may exist over a plurality of buildings, a plurality of sites, a plurality of addresses, or the like. “In the factory FC” also includes a range from completion of the vehicle 100 to a standby location for loading the completed vehicle 100 onto a loading vehicle for shipment. In addition, “the vehicle 100 runs in the factory FC” includes a case where the vehicle 100 runs transport sections between steps present in a plurality of locations, such as the track RT, and a case where the vehicle 100 runs in a step, and further, for example, a case where, to move between factories located in a plurality of locations, the vehicle 100 runs not only private roads but also public roads between the factories.

The pre-step 50 is, for example, an assembly step for assembling components to a vehicle body. The post-step 60 is, for example, an inspection step of the vehicle 100. The vehicle 100 let out of the pre-step 50 becomes an in-process item of the post-step 60 and runs the track RT to reach the post-step 60 that is a running destination. The vehicle 100 enters the post-step 60 upon acquiring permission for entering the post-step 60. The vehicle 100 is completed as a product upon finishing the inspection step as the post-step 60 and then runs to the standby location in the factory FC for standby of the shipment. Thereafter, the vehicle 100 is shipped to a corresponding shipping destination for each vehicle 100. Note that the pre-step 50 and the post-step 60 are not limited to an assembly step and an inspection step, and various steps may be employed as long as the vehicle 100 having been processed by the pre-step 50 and the post-step 60 can run by remote control.

The vehicle detector is used for detecting a position or orientation of the vehicle 100, for example. In the present embodiment, the vehicle detector is a camera 80. The camera 80 is fixed to a position that allows capturing an image of the track RT and the vehicle 100 that is running. The camera 80 acquires an image from which a position of the vehicle 100 relative to the track RT can be checked. The image captured by the camera 80 is used for remote control of the vehicle 100. By using the image captured by the camera 80, automatic running of the vehicle 100 by remote control can be executed without using a detector mounted on the vehicle 100, such as a camera, millimeter wave radar, or LiDAR. However, a detector mounted on the vehicle 100 may be supplementarily used to prevent collisions during remote control by the control system 500. For the vehicle detector, other than the camera 80, various detectors capable of detecting the vehicle 100 may be employed such as an infrared sensor, a laser sensor, an ultrasonic sensor, millimeter wave radar, or LiDAR, as long as it is installed in the factory FC and can acquire a position or orientation of the vehicle 100.

The control system 500 of the present embodiment includes a plurality of the vehicles 100 and a server 300. In FIG. 1, only one of the plurality of vehicles 100 is illustrated, and the other vehicles 100 are not illustrated.

The vehicle 100 includes a battery 110, a driving device 120, a steering device 130, a braking device 140, a communication unit 150, and an ECU 160. The battery 110 stores electric power used for running of the vehicle 100. The driving device 120 is a device group for accelerating the vehicle 100 and, in the present embodiment, includes a motor that is driven by the electric power of the battery 110 and a driving wheel that rotates by the motor. The steering device 130 is a device group for changing a traveling direction of the vehicle 100. The braking device 140 is a device group for decelerating the vehicle 100.

The communication unit 150 is configured to be remotely communicable with an external device of the vehicle 100 via, for example, an access point 70 in the factory FC. The external device of the vehicle 100 is, for example, the server 300 connected to a network 72, an unillustrated production management device that generally manages production management information on the vehicle 100, or the other vehicle 100. In the present embodiment, the communication unit 150 receives a control signal of remote control of the vehicle 100 from the server 300 as described later. In addition, in the present embodiment, the communication unit 150 transmits information indicating a state of the vehicle 100 (hereinafter also referred to as a “vehicle state”) to an external device of the vehicle 100. The “vehicle state” includes a state of the vehicle 100 that changes depending on a running status of the vehicle 100, such as a running distance of the vehicle 100, a battery remaining amount, the number of operations of the driving device 120, or the number of uses of a consumable component such as a brake pad. Further, “a state of the vehicle 100 that changes depending on a running status of the vehicle 100” includes a state of the vehicle 100 that affects the quality of the vehicle 100 in a completed state. Such a vehicle state can be acquired by using output from a sensor that detects an operation status of each of the battery 110, the driving device 120, the steering device 130, and the braking device 140. In the present embodiment, the communication unit 150 transmits to the server 300 information including at least a running distance of the vehicle 100 as the information indicating the vehicle state.

The ECU 160 is mounted on the vehicle 100 and executes various kinds of control of the vehicle 100. The ECU 160 has a CPU and a memory.

The CPU executes a program stored in the memory in advance to function as a driving control unit 161 that executes driving control of the vehicle 100. The “driving control” means, for example, adjustment of acceleration, speed, and steering angle of the vehicle 100.

The server 300 includes a CPU 310 as a central processing unit, a storage device 320, and a communication unit 330, and these are connected to each other via an internal bus, an interface circuit, and the like. The communication unit 330 communicates with the vehicle 100, the unillustrated production management device, and the like, via the network 72.

The storage device 320 is, for example, RAM, ROM, a hard disk drive (HDD), or a solid state drive (SSD). In the present embodiment, the CPU 310 executes a computer program stored in the storage device 320 to function as a state identification unit 311 and a control notification unit 312. Note that some or all of these functions may be configured by a hardware circuit.

The state identification unit 311 acquires information transmitted from each of the vehicles 100 and identifies the vehicle state of each of the vehicles 100. The control notification unit 312 executes automatic running of the vehicle 100 in the factory FC by remote control. More specifically, the control notification unit 312 transmits a control signal for notifying a control content of the vehicle 100 to the vehicle 100 via the communication unit 330. In the present embodiment, the control notification unit 312 uses the identified vehicle state to determine the control content of the vehicle 100 such that a magnitude of a difference between the vehicle state and a preset target state is suppressed. In addition, the control notification unit 312 transmits a control signal indicating the determined control content to the vehicle 100. The “target state” means a target value of a vehicle state preset for standardization of the quality of the vehicle 100.

When the vehicle 100 receives the control signal, the driving control unit 161 executes driving control in accordance with the control signal notified from the control notification unit 312, and consequently the vehicle 100 automatically runs. Transport of the vehicle 100 using automatic running by remote control is also referred to as a “Remote Control auto Driving system.” Thus, in the present embodiment, the vehicle 100 is configured as a “vehicle with a Remote Control auto Driving system” that is capable of performing a Remote Control auto Driving system. The Remote Control auto Driving system of the vehicle 100 can suppress or prevent a human-induced accident when the vehicle 100 runs.

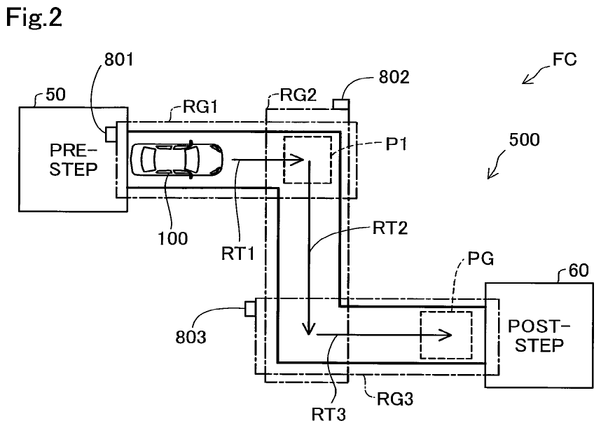

FIG. 2 is an explanatory view illustrating automatic driving control of the vehicle 100 by remote control. In an example of FIG. 2, the track RT includes a first track RT1, a second track RT2, and a third track RT3, which are continuous with each other. The control notification unit 312 causes the vehicle 100 to run to a position PG for entering the post-step 60 along the track RT.

The camera 80 as the vehicle detector acquires an image showing the track RT from above. The number of the cameras 80 is set in consideration of the angles of view of the cameras 80 and the like so that the entire track RT can be captured. In the example of FIG. 2, the camera 80 includes a camera 801 capable of capturing a range RG1 including the entire first track RT1, a camera 802 capable of capturing a range RG2 including the entire second track RT2, and a camera 803 capable of capturing a range RG3 including the entire third track RT3. Note that the camera 80 is not limited to capturing an image from above of the vehicle 100 and may capture an image from front, back, side, or the like of the vehicle 100. In addition, cameras that capture these images may be combined as appropriate.

The track RT includes a preset target route where the vehicle 100 needs to run. The control notification unit 312 causes the driving control unit 161 to execute driving control of the vehicle 100 while analyzing an image of the track RT and the vehicle 100 acquired by the camera 80 at a predetermined time interval. The control notification unit 312 sequentially adjusts the position of the vehicle 100 relative to the target route to allow the vehicle 100 to run along the target route. Note that the remote control may use an image of the entire vehicle 100 or an image of a part of the vehicle 100 such as an alignment mark provided in the vehicle 100.

As in a position P1 illustrated in FIG. 2, the angles of view of the cameras 80 corresponding to the respective connected tracks are configured to overlap with each other at the position connecting the tracks. In an example of the position P1, the angle of view of the camera 801 corresponding to the first track RT1 and the angle of view of the camera 802 corresponding to the second track RT2 overlap with each other. The vehicle 100 let out of the pre-step 50 runs to the position P1 by remote control using an image captured by the camera 801. When the vehicle 100 reaches the position P1, the vehicle 100 switches to remote control using an image captured by the camera 802 instead of the camera 801 and then runs the second track RT2. Similarly, an image captured by the camera 803 is used for running on the third track RT3. Thus, the control notification unit 312 performs remote control of the vehicle 100 while appropriately switching the captured images to be analyzed according to the ranges of the track RT.

### A-2. Transport Control

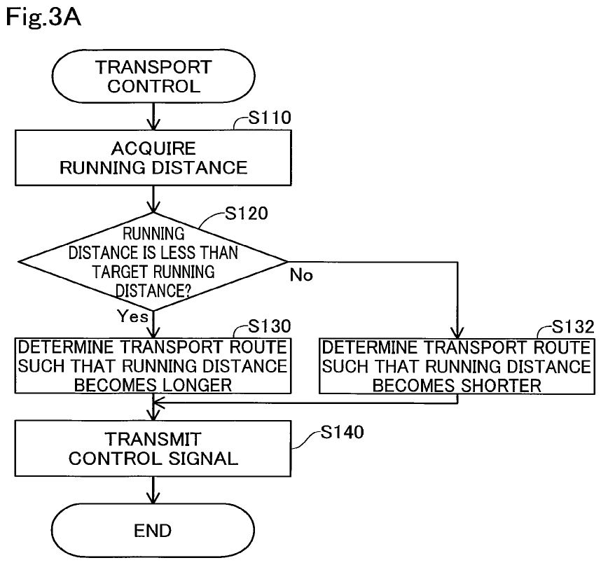

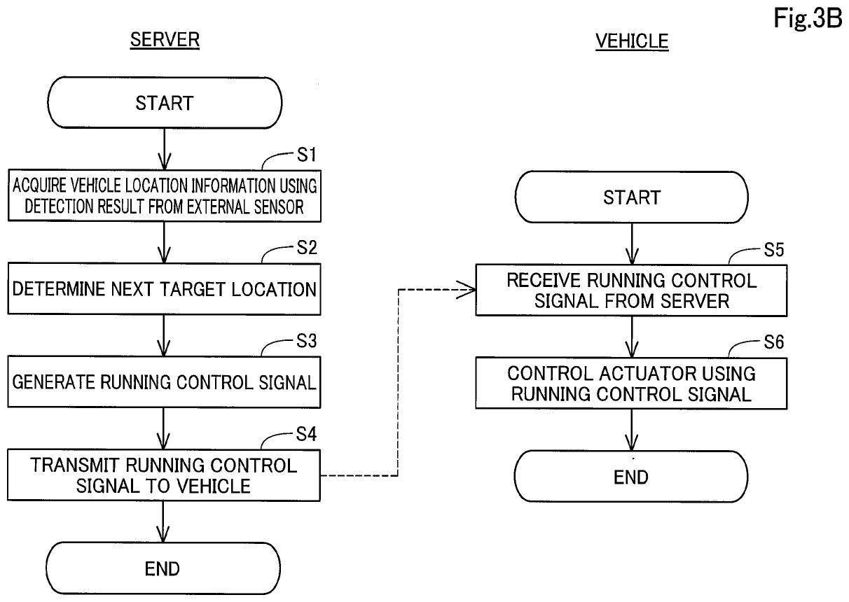

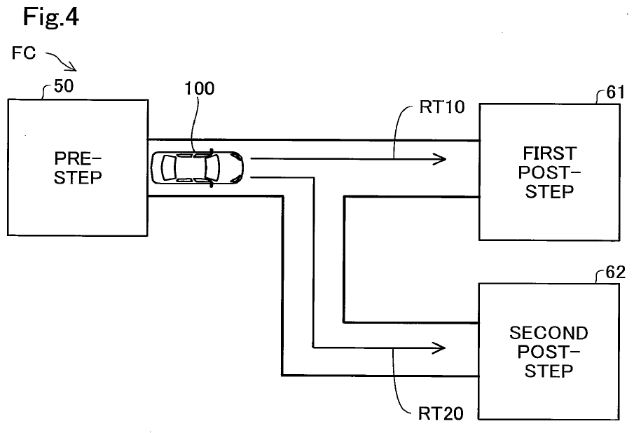

FIG. 3A is a flowchart illustrating a procedure of transport control of the first embodiment. FIG. 3B is a flowchart illustrating a procedure of running control of the first embodiment. FIG. 4 is an explanatory view illustrating an example of how the vehicle 100 is transported by the transport control of the first embodiment. In the present embodiment, in the transport control, the server 300 acquires a running distance of the vehicle 100 from the vehicle 100, determines a transport route of the vehicle 100 such that the running distance of the vehicle 100 approaches a preset target running distance, then performs the notification. Machine learning may be performed in the vehicle 100 for improving the driving quality. In this case, a small running distance may fail to sufficiently improving the driving quality due to insufficient learning. The “target running distance” corresponds to the above-described target state and is preset as a running distance that achieves learning enough to obtain sufficient driving quality. The machine learning is performed in order to appropriately control acceleration and deceleration timings, recognition of an object by a camera, a headlamp illumination angle, and the like. In the present embodiment, the transport control is executed after completion of a certain step and before transport of the vehicle 100 to the next step. The running control is control that is a prerequisite for the transport control. In other words, the running control is executed as basic control, and the transport control is combined with the running control and executed. First, the running control will be described with reference to FIG. 3B.

As shown in FIG. 3, in step S1, the server 300 acquires vehicle location information of the vehicle 100 using detection result output from an external sensor. The external sensor is located outside the vehicle 100. The vehicle location information is locational information as a basis for generating a running control signal. In the present embodiment, the vehicle location information includes the location and orientation of the vehicle 100 in a reference coordinate system of the factory. In the present embodiment, the reference coordinate system of the factory is a global coordinate system and a location in the factory can be expressed by X, Y, and Z coordinates in the global coordinate system. In the present embodiment, the external sensor is a camera 80 as a vehicle detector that is disposed in the factory and outputs a captured image as detection result. In step S1, the server 300 acquires the vehicle location information using the captured image acquired from the camera 80 as the external sensor.

More specifically, in step S1, the server 300 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system, thereby acquiring the location of the vehicle 100. The outer shape of the vehicle 100 in the captured image may be detected by inputting the captured image to a detection model using artificial intelligence, for example. The detection model is prepared in the control system 500 or outside the control system 500. The detection model is stored in advance in the storage device 320 of the server 300, for example. An example of the detection model is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 300 or a region indicating a subject other than the vehicle 100, for example. In training the CNN, a parameter for the CNN is preferably updated through backpropagation in such a manner as to reduce error between output result obtained by the detection model and the label. The server 300 can acquire the orientation of the vehicle 100 through estimation based on the direction of a motion vector of the vehicle 100 detected from change in location of a feature point of the vehicle 100 between frames of the captured images using optical flow process, for example.

In step S2, the server 300 determines a target location to which the vehicle 100 is to move next. In the present embodiment, the target location is expressed by X, Y, and Z coordinates in the global coordinate system. The storage device 320 of the server 300 contains a reference route stored in advance as a route along which the vehicle 100 is to run. The route is expressed by a node indicating a departure place, a node indicating a way point, a node indicating a destination, and a link connecting nodes to each other. The server 300 determines the target location to which the vehicle 100 is to move next using the vehicle location information and the reference route. The server 300 determines the target location on the reference route ahead of a current location of the vehicle 100.

In step S3, the server 300 generates a running control signal (also referred to simply as “control signal”) for causing the vehicle 100 to run toward the determined target location. In the present embodiment, the running control signal includes an acceleration and a steering angle of the vehicle 100 as parameters. The server 300 calculates a running speed of the vehicle 100 from transition of the location of the vehicle 100 and makes comparison between the calculated running speed and a target speed of the vehicle 100 determined in advance. If the running speed is lower than the target speed, the server 300 generally determines an acceleration in such a manner as to accelerate the vehicle 100. If the running speed is higher than the target speed as, the server 300 generally determines an acceleration in such a manner as to decelerate the vehicle 100. If the vehicle 100 is on the reference route, server 200 determines a steering angle and an acceleration in such a manner as to prevent the vehicle 100 from deviating from the reference route. If the vehicle 100 is not on the reference route, in other words, if the vehicle 100 deviates from the reference route, the server 300 determines a steering angle and an acceleration in such a manner as to return the vehicle 100 to the reference route. In other embodiments, the running control signal may include the speed of the vehicle 100 as a parameter instead of or in addition to the acceleration of the vehicle 100.

In step S4, the server 300 transmits the generated running control signal to the vehicle 100. The server 300 repeats the acquisition of vehicle location information, the determination of a target location, the generation of a running control signal, the transmission of the running control signal, and others in a predetermined cycle.

In step S5, the driving controller of the vehicle 100 receives the running control signal transmitted from the server 300. In step S6, the vehicle 100 controls an actuator of the vehicle 100 using the received running control signal, thereby causing the vehicle 100 to run at the acceleration and the steering angle indicated by the running control signal. The vehicle 100 repeats the reception of a running control signal and the control over the actuator in a predetermined cycle. According to the control system 500 in the present embodiment, it becomes possible to move the vehicle 100 without using a transport unit such as a crane or a conveyor.

In an example illustrated in FIG. 4, the factory FC includes the pre-step 50, a first post-step 61, a second post-step 62, a track RT10, and a track RT20. The pre-step 50 is an assembly step of the vehicle 100. The first post-step 61 and the second post-step 62 are both inspection steps for inspecting the vehicle 100 after completion of the pre-step 50 and perform the same inspection at different locations, for example, in different buildings. Note that the first post-step 61 and the second post-step 62 may be performed at different areas in the same building. Further, the pre-step 50 is not limited to an assembly step, and the first post-step 61 and the second post-step 62 are not limited to inspection steps. In addition, the pre-step 50, the first post-step 61, and the second post-step 62 may be steps for assembling different components in an assembly step.

The track RT10 connects the pre-step 50 and the first post-step 61. The track RT20 connects the pre-step 50 and the second post-step 62. The transport distance when the vehicle 100 is transported by running the track RT20 is longer than the transport distance when the vehicle 100 is transported by running the track RT10. In the example illustrated in FIG. 4, the control notification unit 312 transports the vehicle 100 by using any of the track RT10 and the track RT20 as a transport route. Note that the number of candidates for the transport route of the vehicle 100 is not limited to two and may be three or more.

The transport control will be described with reference to FIG. 3A. In step S110 illustrated in FIG. 3A, the state identification unit 311 identifies the running distance of the vehicle 100. More specifically, the state identification unit 311 identifies the running distance from the time when the vehicle 100 becomes able to autonomously run by remote control to the time when the pre-step 50 ends. The running distance of the vehicle 100 can be identified by, for example, acquiring information from a sensor for measuring temporal changes in rotational frequency of driving wheels included in the vehicle 100.

In step S120, the control notification unit 312 determines whether the running distance of the vehicle 100 is less than a preset target running distance. When the running distance is less than the target running distance (Yes in step S120), the control notification unit 312 determines the transport route in step S130 such that the running distance of the vehicle 100 becomes longer. In the example of FIG. 4, the control notification unit 312 determines the transport route such that the vehicle 100 is transported by running the track RT20 that has a longer transport distance than the track RT10. The vehicle 100 is transported by running the track RT20, so that the running distance of the vehicle 100 becomes longer than in the case where the vehicle 100 is transported by running the track RT10, suppressing the magnitude of the difference between the running distance of the vehicle 100 and the target running distance.

On the other hand, as illustrated in FIG. 3A, when the running distance is equal to or more than the target running distance (No in step S120), the control notification unit 312 determines the transport route in step S132 such that the running distance of the vehicle 100 becomes shorter. In the example of FIG. 4, the control notification unit 312 determines the control content of the vehicle 100 such that the vehicle 100 is transported by running the track RT10 that has a shorter transport distance than the track RT20. The vehicle 100 is transported by running the track RT10, so that the time required for transport of the vehicle 100 can be suppressed.

In step S140, the control notification unit 312 transmits to the vehicle 100 a control signal (running control signal) for notifying of running in accordance with the determined transport route as the control content. The driving control unit 161 executes driving control of the own vehicle in accordance with the control signal from the control notification unit 312. Then, the transport control of the present embodiment ends.

According to the control system 500 of the first embodiment described above, the transport route of the vehicle 100 is determined such that the magnitude of the difference between the running distance of the vehicle 100 and the target running distance is suppressed, and running the determined transport route is determined as the control content and notified to the vehicle 100, so that the control content notified to the vehicle 100 is executed by the vehicle itself, suppressing occurrence of variations in the running distance of the vehicle 100.

### B. Second Embodiment

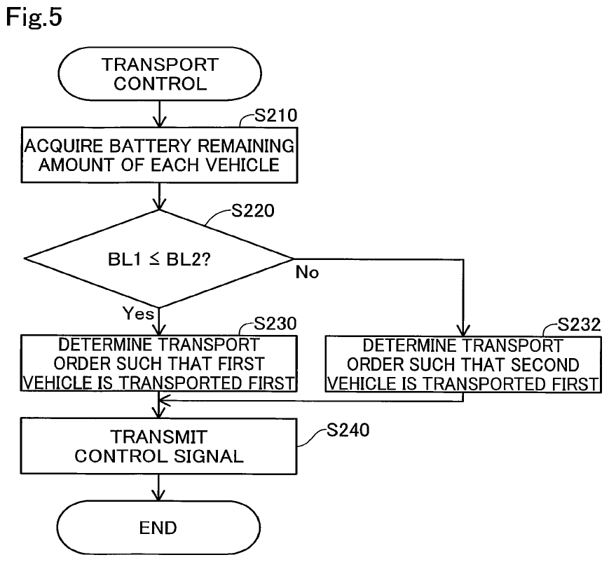

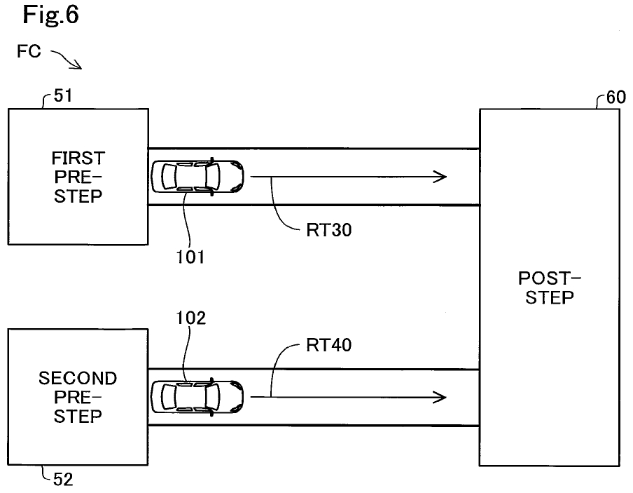

FIG. 5 is a flowchart illustrating a procedure of transport control of a second embodiment. FIG. 6 is an explanatory view illustrating an example of how the vehicle 100 is transported by the transport control of the second embodiment. The control system 500 of the second embodiment is different from the control system 500 of the first embodiment in that the communication unit 150 transmits a remaining amount of the battery 110 to the server 300 as the vehicle state, and in that the transport control illustrated in FIG. 5 is executed instead of the transport control illustrated in FIG. 3A. Note that the system configurations of the control system 500 of the second embodiment is the same as those of the control system 500 of the first embodiment, and accordingly the same configurations are denoted by the same reference numerals, and a detailed description thereof will be omitted.

In the present embodiment, in the transport control, the server 300 acquires the battery remaining amount of each of the plurality of vehicles 100, determines the transport order of the plurality of vehicles 100 such that the magnitude of the difference between the battery remaining amount of the vehicle 100 and a preset target battery remaining amount is suppressed, and notifies each of the vehicles 100 of the transport order. The “target battery remaining amount” corresponds to the above-described target state and means a target value of a battery remaining amount preset for standardization of the performance of the battery 110 mounted on each of the vehicles 100. In the present embodiment, the same target battery remaining amount is set for each of the vehicles.

In the present embodiment, the server 300 determines the transport order of, among the plurality of vehicles 100, vehicles 100 that are present within a preset distance and have the same destination as the transport destination within a preset time. The transport destination of each of the vehicles 100 is set by, for example, the unillustrated production management device installed in each of the steps upon the end of this step and is transmitted to the server 300.

In the example illustrated in FIG. 6, the factory FC includes a first pre-step 51, a second pre-step 52, the post-step 60, a track RT30, and a track RT40. The first pre-step 51 and the second pre-step 52 are both assembly steps of the vehicle 100 and are performed at different locations, for example, in different buildings. Note that the first pre-step 51 and the second pre-step 52 may be performed at different areas in the same building. Further, the first pre-step 51 and the second pre-step 52 may be steps for assembling different components or steps for targeting different vehicle types, as long as these steps are performed before the post-step 60. The post-step 60 is an inspection step for inspecting the vehicle 100 after completion of the first pre-step 51 or the second pre-step 52. Note that the first pre-step 51 and the second pre-step 52 are not limited to assembly steps, and the post-step 60 is not limited to an inspection step. Further, the first pre-step 51, the second pre-step 52, and the post-step 60 may be, for example, steps for assembling different components in an assembly step.

The track RT30 connects the first pre-step 51 and the post-step 60. In FIG. 6, a first vehicle 101 runs the track RT30 and is transported from the first pre-step 51 to the post-step 60. The track RT40 connects the second pre-step 52 and the post-step 60. In FIG. 6, a second vehicle 102 runs the track RT40 and is transported from the second pre-step 52 to the post-step 60. In FIG. 6, the first vehicle 101 and the second vehicle 102 are in a state of waiting for transport. Note that the number of the vehicles 100 waiting for transport to the post-step 60 is not limited to two and may be three or more. Further, two or more vehicles 100 may wait for transport to the post-step 60 in each of the first pre-step 51 and the second pre-step 52. In addition, in a pre-step different from the first pre-step 51 and the second pre-step 52, a vehicle different from the first vehicle 101 and the second vehicle 102 may wait for transport to the post-step 60.

In step S210 illustrated in FIG. 5, the state identification unit 311 identifies the battery remaining amount of each of the vehicles 100. In the example illustrated in FIG. 6, the state identification unit 311 identifies a battery remaining amount BL1 of the battery 110 mounted on the first vehicle 101 and a battery remaining amount BL2 of the battery 110 mounted on the second vehicle 102.

In step S120 illustrated in FIG. 5, the control notification unit 312 determines whether the battery remaining amount BL1 is equal to or less than the battery remaining amount BL2. When the battery remaining amount BL1 is equal to or less than the battery remaining amount BL2 (Yes in step S220), the control notification unit 312 determines the transport order in step S230 such that the first vehicle 101 having a smaller battery remaining amount than the second vehicle 102 is transported first. The transport order is thus determined, so that the standby time of the first vehicle 101 becomes shorter than in the case where the transport order of the first vehicle 101 is after the second vehicle 102. This can suppress electric power (standby power) consumed in the first vehicle 101 during the standby time, suppressing an increase in the magnitude of the difference between the battery remaining amount BL1 and the target battery remaining amount.

On the other hand, when the battery remaining amount BL1 is larger than the battery remaining amount BL2 (No in step S220), the control notification unit 312 determines the transport order as the control content in step S232 such that the second vehicle 102 having a smaller battery remaining amount than the first vehicle 101 is transported first. The transport order is thus determined, so that the standby time of the second vehicle 102 becomes shorter than in the case where the transport order of the second vehicle 102 is after the first vehicle 101. This can suppress standby power in the second vehicle 102, suppressing an increase in the magnitude of the difference between the battery remaining amount BL2 and the target battery remaining amount.

In step S240, the control notification unit 312 transmits to each of the first vehicle 101 and the second vehicle 102 a control signal for notifying of running in accordance with the determined transport order as the control content. The driving control unit 161 mounted on each of the first vehicle 101 and the second vehicle 102 executes driving control of the own vehicle in accordance with the control signal from the control notification unit 312. Then, the transport control of the present embodiment ends.

According to the control system 500 of the second embodiment described above, the battery remaining amount is acquired as the vehicle state, the transport order is determined such that, between the first vehicle 101 and the second vehicle 102, a vehicle having a smaller battery remaining amount is transported earlier, and running in accordance with the transport order is notified to each of the vehicles as the control content, so that the vehicles can run in the transport order determined in accordance with the control content notified to each of the vehicles, suppressing occurrence of variations in the vehicle state.

### C. Third Embodiment

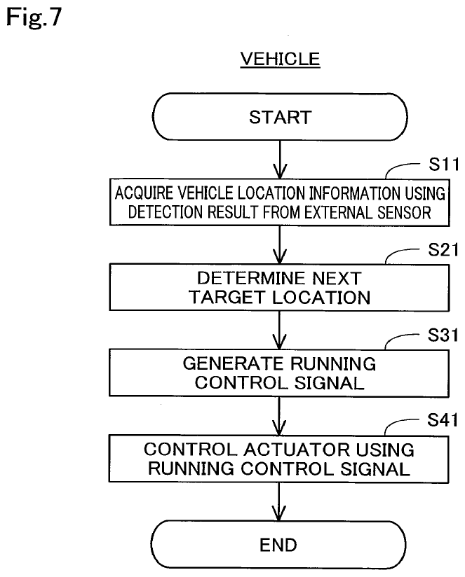

FIG. 7 is a flowchart showing a processing procedure for running control of the vehicle 100 in the third embodiment. Since the configuration of the vehicle 100 in the present embodiment is the same as in the first embodiment, the vehicle in the present embodiment is denoted as vehicle 100 for convenience. In step S101, the vehicle 100 acquires vehicle location information using detection result output from the camera 80 as an external sensor. In step S102, the vehicle 100 determines a target location to which the vehicle 100 is to move next. In step S103, the vehicle 100 generates a running control signal for causing the vehicle 100 to run to the determined target location. In step S104, the vehicle 100 controls an actuator using the generated running control signal, thereby causing the vehicle 100 to run by following a parameter indicated by the running control signal. The vehicle 100 repeats the acquisition of vehicle location information, the determination of a target location, the generation of a running control signal, and the control over the actuator in a predetermined cycle. According to the automatic driving system 500 in the present embodiment, it is possible to cause the vehicle 100 to run by autonomous control without controlling the vehicle 100 remotely using the server 300.

### D. Other Embodiments

(D1) In the above embodiments, the control notification unit 312 determines the transport route or the transport order as the control for suppressing the magnitude of the difference between the vehicle state and the target state; however, the present disclosure is not limited to this. In addition to the above-described control, for example, the control notification unit 312 may cause the vehicle 100 being transported to accelerate or decelerate. The vehicle 100 is caused to accelerate or decelerate, so that the power consumption amount can be adjusted, suppressing the magnitude of the difference between the battery remaining amount and the target battery remaining amount. Further, the vehicle 100 is caused to accelerate or decelerate, so that the number of uses of the brake pad can be adjusted, suppressing the magnitude of the difference between such the number of uses and the target number of uses. “The target number of uses” corresponds to the above-described target state and means a target value of the number of uses of the brake pad preset for standardization of the wear state of the brake pad.

Further, when the vehicle 100 is configured as a gasoline automobile, the control notification unit 312 may repeatedly cause the vehicle 100 to execute start and stop of the engine. Start and stop of the engine is repeatedly executed, so that the number of starts of the engine can be adjusted, suppressing the magnitude of the difference between such the number of starts and the target number of starts. “The target number of starts” corresponds to the above-described standard state and means the number of starts of the engine preset for sufficiently stabilizing a catalytic reaction in the engine.

Further, the control notification unit 312 may control the operation of an auxiliary machine such as an air conditioner or an audio device included in the vehicle 100, during transport or standby for the transport order. The auxiliary machine is operated when the battery remaining amount exceeds the target battery remaining amount, so that the power consumption is promoted, suppressing the magnitude of the difference between the battery remaining amount and the target battery remaining amount. According to the control described above, not limited to the running distance and the battery remaining amount, the magnitudes of the differences between various vehicle states of the vehicle 100 and the target states can be suppressed.
(D2) In the above embodiments, the vehicle 100 is configured as a vehicle with a remote Control auto Driving system that receives a control signal transmitted from the server 300 and is remotely controlled to execute the Remote Control auto Driving system; however, the present disclosure is not limited to this. The vehicle 100 may be transported by driving control performed by a driver. In such a configuration, the vehicle 100 may notify the driver of the control content upon reception of the control signal through, for example, displaying the control content on a display included in the vehicle 100 or notifying of the control content with a speaker included in the vehicle 100. The driver performing driving control of the vehicle 100 in accordance with the control content thus notified also can suppress the magnitude of the difference between the vehicle state and the target state, similarly to the above-described embodiments.
(D3) In the above embodiments, the server 300 includes the state identification unit 311 and the control notification unit 312, and the control content is determined by using the vehicle state acquired from the vehicle 100; however, the present disclosure is not limited to this. The vehicle 100 may include the state identification unit 311 and the control notification unit 312. In such a configuration, the state identification unit 311 may acquire the vehicle state of the own vehicle, and the control notification unit 312 may determine the transport route of the own vehicle by using the acquired vehicle state of the own vehicle. Further, the state identification unit 311 may acquire the vehicle state of the other vehicle 100 in addition to the vehicle state of the own vehicle and determine the transport order of the plurality of vehicles 100 by using the vehicle state of each of the vehicles 100. Such a configuration also provides effects similar to those of the above-described embodiments.
(D4) In the second embodiment, the control notification unit 312 compares the battery remaining amount BL1 and the battery remaining amount BL2 and determines the transport order such that, between the first vehicle 101 and the second vehicle 102, a vehicle having a smaller battery remaining amount is transported earlier; however, the present disclosure is not limited to this. When different target battery remaining amounts are set in a plurality of the vehicles 100, the control notification unit 312 may calculate the magnitude of the difference between the battery remaining amount of the vehicle and the target battery remaining amount for each of the vehicles 100 and determine the transport order such that a vehicle having a larger magnitude of the difference is transported earlier. Further, the control notification unit 312 may calculate the proportion of the battery remaining amount to the target battery remaining amount for each of the vehicles 100 and determine the transport order such that a vehicle having the smaller proportion is transported earlier. According to such a configuration, even when a target state different for each of the vehicles 100 is set, the magnitude of the difference between the vehicle state of the vehicle 100 and the target state can be suppressed for each of the vehicles 100.
(D5) In the second embodiment, the control notification unit 312 suppresses the magnitude of the difference between the battery remaining amount and the target battery remaining amount by determining the transport order of the first vehicle 101 and the second vehicle 102, in other words, by determining the timing of starting transport of each of the first vehicle 101 and the second vehicle 102; however, the present disclosure is not limited to this. The control notification unit 312 may target one vehicle 100 and determine the timing of starting transport of the vehicle. For example, when the control notification unit 312 determines the timing of starting transport of the vehicle 100 such that start of transport of the vehicle 100 is delayed, the standby time of the vehicle 100 becomes longer than in the case of starting transport immediately after the end of the pre-step, increasing standby power. Further, start and stop of the engine is repeatedly executed during standby, so that stabilization of a catalytic reaction in the engine can be promoted. In addition, an auxiliary machine is operated during standby, so that power consumption can be promoted. As described above, the magnitudes of the differences between various vehicle states of the vehicle 100 and the target states can be suppressed according to the timing of starting transport of the vehicle 100.
(D6) In each of the above-described embodiments, the vehicle detector (the external sensor) is not limited to the camera 80 but may be the distance measuring device, for example. The distance measuring device is a light detection and ranging (LIDAR) device, for example. In this case, detection result output from the external sensor may be three-dimensional point cloud data representing the vehicle 100. The server 300 and the vehicle 100 may acquire the vehicle location information through template matching using the three-dimensional point cloud data as the detection result and reference point cloud data, for example.
(D7) In the above-described first and the second embodiments, the server 300 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.
(1) The server 300 may acquire vehicle location information, determine a target location to which the vehicle 100 is to move next, and generate a route from a current location of the vehicle 100 indicated by the acquired vehicle location information to the target location. The server 300 may generate a route to the target location between the current location and a destination or generate a route to the destination. The server 300 may transmit the generated route to the vehicle 100. The vehicle 100 may generate a running control signal in such a manner as to cause the vehicle 100 to run along the route received from the server 300 and control an actuator of the vehicle 100 using the generated running control signal.
(2) The server 300 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control an actuator using the generated running control signal.
(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 300 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.
(D8) In the above-described fourth embodiment, the vehicle 100 may be equipped with an internal sensor, and detection result output from the internal sensor may be used in at least one of generation of a route and generation of a running control signal. For example, the vehicle 100 may acquire detection result from the internal sensor, and in generating the route, may reflect the detection result from the internal sensor in the route. The vehicle 100 may acquire detection result from the internal sensor, and in generating the running control signal, may reflect the detection result from the internal sensor in the running control signal.
(D9) In the above-described third embodiment, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control an actuator of the vehicle 100 using the generated running control signal. In this case, the vehicle 100 is capable of running without using any detection result from an external sensor. The vehicle 100 may acquire target arrival time or traffic congestion information from outside the vehicle 100 and reflect the target arrival time or traffic congestion information in at least one of the route and the running control signal. The functional configuration of the control system 500 may be entirely provided at the vehicle 100. Specifically, the processes realized by the control system 500 in the present disclosure may be realized by the vehicle 100 alone.
(D10) In the above-described first and the second embodiments, the server 300 automatically generates a running control signal to be transmitted to the vehicle 100. By contrast, the server 300 may generate a running control signal to be transmitted to the vehicle 100 in response to operation by an external operator existing outside the vehicle 100. For example, the external operator may operate an operating device including a display on which a captured image output from the external sensor is displayed, steering, an accelerator pedal, and a brake pedal for operating the vehicle 100 remotely, and a communication device for making communication with the server 300 through wire communication or wireless communication, for example, and the server 300 may generate a running control signal responsive to the operation on the operating device. Note that driving of the vehicle 100 by such control is referred to as “unmanned driving.” In the above configuration, the information on the determined transport route or transport order may be displayed on a display of an operating device (remote cockpit). Further, when the transport route or the transport order is changed, the changed transport route or transport order may be displayed on the above display. In addition, when the transport route or the transport order is changed, the unmanned driving may be canceled, and the remote automatic driving may be started to run the changed transport route or to run in the changed transport order.
(D11) In each of the above-described embodiments, the vehicle 100 is simply required to have a configuration to become movable by unmanned driving. The vehicle 100 may embodied as a platform having the following configuration, for example. The vehicle 100 is simply required to include at least actuators and a controller. More specifically, in order to fulfill three functions including “run,” “turn,” and “stop” by unmanned driving, the actuators may include a driving device, a steering device and a breaking device. The actuators are controlled by the controller that controls running of the vehicle 100. In order for the vehicle 100 to acquire information from outside for unmanned driving, the vehicle 100 is simply required to include the communication device further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from a factory, or a remaining component such as a bodyshell may be mounted on the vehicle 100 after the vehicle 100 is shipped from a factory while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first and the second embodiments.
(D12) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.
(D13) A configuration for realizing running of a vehicle 100 by unmanned driving is also called a “Remote Control auto Driving system”. Conveying a vehicle using Remote Control Auto Driving system is also called “self-running conveyance”. Producing the vehicle 100 using self-running conveyance is also called “self-running production”. In self-running production, for example, at least part of the conveyance of vehicles is realized by self-running conveyance in a factory where the vehicle 100 is manufactured.

The present disclosure is not limited to the above-described embodiments and can be carried out with various configurations without departing from the spirit and scope of the present disclosure. For example, the technical features in the embodiments corresponding to the technical features in the aspects described in the column of summary can be replaced or combined, as appropriate, to solve some or all of the problems described above or achieve some or all of the effects described above. In addition, the technical features can be deleted, as appropriate, unless such technical features are described as essential herein. For example, the present disclosure may be implemented by aspects described below.
(1) According to one aspect of the present disclosure, a control system is provided. The control system controls transport of a vehicle in any of steps from production to shipment of the vehicle and includes a state identification unit that identifies a vehicle state that is a state of the vehicle, and a control notification unit that determines a control content of the vehicle by using the identified vehicle state and notifies the vehicle of the control content, wherein the control notification unit determines to control at least either one of a transport route of the vehicle and a timing of starting the transport as the control content such that a magnitude of a difference between the vehicle state and a preset target state is suppressed.
According to the control system of this aspect, controlling at least either one of the transport route of the vehicle and the timing of starting the transport such that the magnitude of the difference between the vehicle state and the target state is suppressed is determined as the control content of the vehicle by using the identified vehicle state and is notified to the vehicle, so that occurrence of variations in the vehicle state can be suppressed by the vehicle itself or an operator executing the control content notified to the vehicle.
(2) In the above aspect, the vehicle may be configured as a vehicle with a Remote Control auto Driving system including a driving control unit that executes driving control of the vehicle in accordance with the control content notified from the control notification unit.
According to the control system of this aspect, it is possible to suppress occurrence of variations in the vehicle state of the vehicle configured as a vehicle with a Remote Control auto Driving system.
(3) In the above aspect, the control system may control the transport of a plurality of the vehicles, the state identification unit may identify the vehicle state of each of the vehicles, and the control notification unit may determine a transport order of each of the vehicles by using the vehicle state of each of the vehicles such that a magnitude of a difference between the vehicle state and the target state for at least some of the plurality of vehicles is suppressed, and notify each of the vehicles of running in accordance with the transport order as the control content.
According to the control system of this aspect, the vehicle state of each of the vehicles is identified, the transport order is determined by using the vehicle state of each of the vehicles such that, for at least some of the vehicles, the vehicle state approaches the target state, and running in accordance with the transport order is notified to the vehicle as the control content, so that the vehicles can run in the transport order determined in accordance with the control content notified to each of the vehicles, suppressing occurrence of variations in the vehicle state.
(4) In the above aspect, each of the vehicles may include a battery that stores electric power used for running of the vehicle, the state identification unit may acquire a remaining amount of the battery as the vehicle state, and the control notification unit may determine the transport order such that, among the plurality of vehicles, a second vehicle having a smaller remaining amount of the battery than a first vehicle is transported earlier than the first vehicle.
According to the control system of this aspect, the remaining amount of the battery is acquired as the vehicle state, the transport order is determined such that the second vehicle having a smaller battery remaining amount than the first vehicle is transported earlier than the first vehicle, and running in accordance with the transport order is notified to each of the vehicles as the control content, so that the vehicles can run in the transport order determined in accordance with the control content notified to each of the vehicles, suppressing occurrence of variations in the remaining amount of the battery of each of the vehicles.
(5) According to another aspect of the present disclosure, provided is a server used in a control system for controlling transport of a vehicle in any of steps from production to shipment of the vehicle. The server includes a state identification unit that identifies a vehicle state that is a state of the vehicle, and a control notification unit that determines a control content of the vehicle by using the identified vehicle state and transmits a running control signal indicating the control content to the vehicle. The control notification unit determines to control at least either one of a transport route of the vehicle and a timing of starting the transport as the control content such that a magnitude of a difference between the vehicle state and a preset target state is suppressed.
According to the server of this aspect, controlling at least either one of the transport route of the vehicle and the timing of starting the transport such that the magnitude of the difference between the vehicle state and the target state is suppressed is determined as the control content of the vehicle by using the identified vehicle state and is notified to the vehicle as the running control signal, so that occurrence of variations in the vehicle state can be suppressed by the vehicle itself or an operator executing the control content notified to the vehicle.
(6) According to another aspect of the present disclosure, provided is a vehicle transported in any of steps from production to shipment. The vehicle includes a driving control unit that executes driving control during transport of the vehicle, a state identification unit that identifies a vehicle state that is a state of the vehicle, and a control notification unit that determines a control content of the driving control by using the identified vehicle state and transmits a running control signal indicating the control content to the driving control unit. The control notification unit determines to control at least either one of a transport route of the vehicle and a timing of starting the transport as the control content such that a magnitude of a difference between the vehicle state and a preset target state is suppressed.
According to the vehicle of this aspect, the control notification unit uses the identified vehicle state to determine to control at least either one of the transport route of the vehicle and the timing of starting the transport as the control content of the vehicle such that the magnitude of the difference between the vehicle state and the target state is suppressed, and notifies the driving control unit of it as the running control signal. In addition, the driving control unit uses the received running control signal to execute driving control. Therefore, occurrence of variations in the vehicle state can be suppressed.
(7) According to another aspect of the present disclosure, provided is a vehicle transported in any of steps from production to shipment. The vehicle receives from a server a running control signal indicating a control content of driving control during transport of the vehicle and executes the driving control by using the received running control signal. The server includes a state identification unit that identifies a vehicle state that is a state of the vehicle, and a control notification unit that determines the control content by using the identified vehicle state and transmits the running control signal to the vehicle. The control notification unit determines to control at least either one of a transport route of the vehicle and a timing of starting the transport as the control content such that a magnitude of a difference between the vehicle state and a preset target state is suppressed.
According to the vehicle of this aspect, the driving control is executed by using the received running control signal, and this running control signal is a signal transmitted to the vehicle by the server using the identified vehicle state and determining to control at least either one of the transport route of the vehicle and the timing of starting the transport as the control content of the vehicle such that the magnitude of the difference between the vehicle state and the target state is suppressed, so that occurrence of variations in the vehicle state can be suppressed.

What is claimed is:

1. A control system for controlling transport of a vehicle in any of steps from production to shipment of the vehicle, the system comprising:
a state identification unit configured to identify a vehicle state that is a state of the vehicle; and
a control notification unit configured to determine a control content of the vehicle by using the identified vehicle state and notify the vehicle of the control content,
wherein the control notification unit is configured to determine to control at least either one of a transport route of the vehicle and a timing of starting the transport as the control content such that a magnitude of a difference between the vehicle state and a preset target state is suppressed.

2. The control system according to claim 1, wherein the vehicle is configured as a vehicle with a Remote Control auto Driving system including a driving control unit configured to execute driving control of the vehicle in accordance with the control content notified from the control notification unit.

3. The control system according to claim 1,
wherein the control system is configured to control the transport of a plurality of the vehicles,
the state identification unit is configured to identify the vehicle state of each of the vehicles, and
the control notification unit is configured to determine a transport order of each of the vehicles by using the vehicle state of each of the vehicles such that a magnitude of a difference between the vehicle state and the target state for at least some of the plurality of vehicles is suppressed, and notify each of the vehicles of running in accordance with the transport order as the control content.

4. The control system according to claim 3,
wherein each of the vehicles includes a battery that stores electric power used for running of the vehicle,
the state identification unit is configured to acquire a remaining amount of the battery as the vehicle state, and
the control notification unit is configured to determine the transport order such that, among the plurality of vehicles, a second vehicle having a smaller remaining amount of the battery than a first vehicle is transported earlier than the first vehicle.

5. A server used in a control system for controlling transport of a vehicle in any of steps from production to shipment of the vehicle, the server comprising:
a state identification unit configured to identify a vehicle state that is a state of the vehicle; and
a control notification unit configured to determine a control content of the vehicle by using the identified vehicle state and transmit a running control signal indicating the control content to the vehicle,
wherein the control notification unit is configured to determine to control at least either one of a transport route of the vehicle and a timing of starting the transport as the control content such that a magnitude of a difference between the vehicle state and a preset target state is suppressed.

6. A vehicle transported in any of steps from production to shipment, the vehicle comprising:
a driving control unit configured to execute driving control during transport of the vehicle;
a state identification unit configured to identify a vehicle state that is a state of the vehicle; and
a control notification unit configured to determine a control content of the driving control by using the identified vehicle state and transmit a running control signal indicating the control content to the driving control unit,
wherein the control notification unit is configured to determine to control at least either one of a transport route of the vehicle and a timing of starting the transport as the control content such that a magnitude of a difference between the vehicle state and a preset target state is suppressed.

7. A vehicle transported in any of steps from production to shipment,
the vehicle being configured to receive from a server a running control signal indicating a control content of driving control during transport of the vehicle and execute the driving control by using the received running control signal,
the server comprising:
a state identification unit configured to identify a vehicle state that is a state of the vehicle; and
a control notification unit configured to determine the control content by using the identified vehicle state and transmit the running control signal to the vehicle,
wherein the control notification unit is configured to determine to control at least either one of a transport route of the vehicle and a timing of starting the transport as the control content such that a magnitude of a difference between the vehicle state and a preset target state is suppressed.
